(19) United States
(12) Patent Application Publication
(10) Pub. No.: US 2007/0127355 A1
(43) Pub. Date: Jun. 7, 2007

(54) Method and apparatus of noise variance estimation for use in wireless communication systems

(75) Inventors: Yan Li, Shanghai (CN); Luzhou Xu, Shanghai (CN); Yueheng Li, Shanghai (CN)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/588,252

(22) PCT Filed: Dec. 2, 2004
(86) PCT No.: PCT/IB04/52631

§ 371 Date: Aug. 2, 2006

(30) Foreign Application Priority Data
Dec. 5, 2003 (CN) 2003101197784.1

(51) Int. Cl. H04J 3/10

(52) U.S. Cl. 370/201

(57) ABSTRACT

A method of noise variance estimation to be performed by a user equipment is proposed, comprising steps of: receiving a signal vector containing training sequence and noise vector transmitted via at least one transmission path; estimating the channel impulse response of each transmission path to construct a channel impulse response matrix, according to the signal vector; calculating the noise variance of the signal vector according to the channel impulse response matrix and the signal vector if the channel impulse response remains mainly unchanged during the special time duration of the training sequence.

### FIELD OF THE INVENTION

The present invention relates generally to a method and apparatus of noise variance estimation for use in wireless communication systems, and more particularly, to a method and apparatus of noise variance estimation by exploiting the training sequence.

### BACKGROUND OF THE INVENTION

CDMA (Code Division Multiple Access) is a new wireless communication technology developed after FDMA (Frequency Division Multiple Access) and TDMA (Time Division Multiple Access). In CDMA wireless communication, different UEs (user equipments) are allocated with different orthogonal spreading codes, and signals spread by different UEs with different spreading codes can be transferred on the same frequency band.

A CDMA downlink transmission model is put forward in the paper entitled “Data Detection Algorithms Specially Designed For The Downlink of CDMA Mobile Radio Systems”, VTC, 1997, by A. Klein, as shown in FIG. 1. In order to transmit signal vectors d⁽¹⁾, . . . , d^{(k)}, . . . , d^{(K)} (wherein d^{(k)} (k=1 . . . K) is composed of N complex components) to UE1, . . . , UEk, . . . UEK respectively, base station 200 first spreads signal vectors d⁽¹⁾, . . . , d^{(k)}, . . . , d^{(k)} by exploiting spreading codes c_{d}⁽¹⁾, . . . , c_{d}^{(k)}, . . . , c_{d}^{(K)} allocated to UE1, . . . , UEk, . . . , UEK, then combines the spread signal vectors into signal vector s_{d} and transmits it to each corresponding UE 220 via the same channel 210. Assumed that signal vector s_{d} reaches UEK (K=1 . . . K) through multiple propagation paths and the CIR (channel impulse response) of each propagation channel is h_{d(i)}^{(k)} (i=1, 2, . . . ), signal vector e_{d}^{(k)} received by UEK can be expressed by equation (1) as follows:
e_{d}^{(k)}=H_{d}^{(k)}C_{d}d+n_{d}^{(k)}=H_{d}^{(k)}s_{d}+n_{d}^{(k)} (1)

wherein H_{d}^{(k)} is the CIR matrix constructed with the CIR h_{d(i)}^{(k)} (i=1, 2, . . . ) of each propagation channel, C_{d} is the spreading code matrix constructed with spreading codes c_{d}⁽¹⁾, . . . , c_{d}^{(k)}, . . . , c_{d}^{(K)} (as to the construction methods of H_{d}^{(k)} and C_{d}, referring to the above paper by A. Klein), d=(d^{(1)T}, . . . , d^{(k)T}, . . . , d^{(K)T})^{T}, [.]^{T} represents matrix transposition, s_{d} represents the obtained signal vector after d is spread and combined, s_{d}=C_{d}d, and n_{d}^{(k)} is the noise vector.

Equation (1) indicates that the received signal vector e_{d}^{(k)} contains UEk's desired signal vector d^{(k)}, as well as signal vectors sent to other UEs by the base station and the noise vector.

To help UEK to obtain its desired signal vector d^{(k)} from the received signal vector e_{d}^{(k)} with the minimum error, many method for signal reception have been presented, which can be referred to “Iterative Multiuser Receiver/Decoders With Enhanced variance Estimation”, VTC, 1999, by Kimmo Kettunen, and “Zero Forcing an Mininum Mean-Square-Error Equalization for Multiuser Detection in Code-Division multiple-access channels”, IEEE Transactions on Vehicular Technology, vol. 45, pp. 276-287, May 1996, by A. Klein. But these methods for signal reception all rely heavily on the channel information, or namely noise variance, to obtain the desired signal vector from the received signal vector, and thus the noise variance needs to be computed precisely to obtain the desired signal vector with minimum error.

To get an accurate noise variance, various noise estimation methods have been put forward. For example, a conventional variance estimation technique for use in AWGN channel is raised in “A novel variance estimator for turbo-code decoding”, Proc. Of ITC'97, pp 173-178, April 1997, by M. Reed and J. Asenstorfer; a Rake technique for alleviating multipath interference is put forward in US. PAT US200220110199, entitled “Method for Noise Energy Estimation in TDMA Systems”. Additionally, there are some noise estimation methods in which noise variance is computed by convolving the training sequence. These noise estimation methods can meet the precision requirement of 2G wireless communication systems.

But in 3G wireless communication systems, more accurate noise variance is needed for signal reception, for example, the key technologies of multiuser detection and turbo-code both have high requirement for accurate noise variance. Current noise estimation methods can't satisfy the precision requirement for noise variance of 3G wireless communication systems.

### SUMMARY OF THE INVENTION

An object of the present invention is to provide a method and apparatus of noise variance estimation for use in wireless communication systems, in which the training sequence is exploited to compute noise variance to obtain more accurate noise variance.

A method of noise variance estimation is proposed in the present invention for use in wireless communication systems, comprising steps of: receiving a signal vector containing training sequence and noise vector transmitted via at least one propagation path from the base station; estimating, according to the signal vector, the channel impulse response of each propagation path to construct a channel impulse response matrix; calculating the noise variance of the signal vector according to the channel impulse response matrix and the signal vector if the channel impulse response remains primarily unchanged during the special time duration of the training sequence.

### BRIEF DESCRIPTION OF THE DRAWINGS

FIG. 1 illustrates conventional CDMA downlink transmission model;

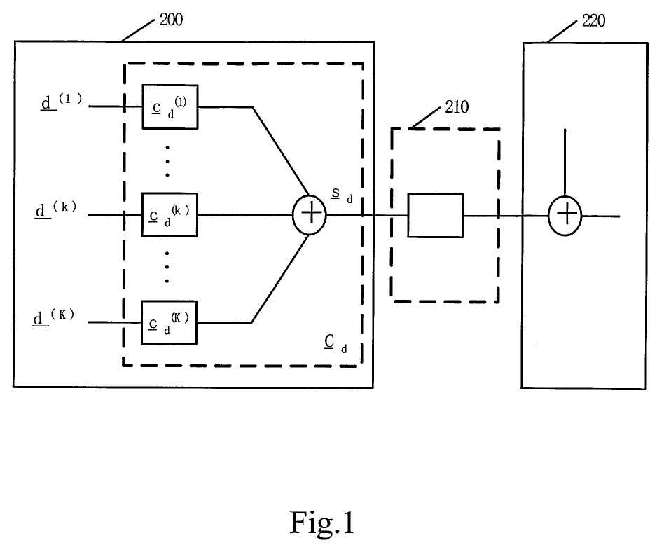

FIG. 2 is a flow chart illustrating the noise variance estimation method in the present invention;

FIG. 3 is a block diagram illustrating the UE equipped with the noise variance estimation apparatus in an embodiment of the present invention;

FIG. 4 is a block diagram illustrating the noise variance estimation apparatus in an embodiment of the present invention.

### DETAILED DESCRIPTION OF THE INVENTION

TD-SCDMA will be exemplified in the following to describe an embodiment of the present invention in detail.

In TD-SCDMA, the base station transmits signal vector to each UE in corresponding timeslot. According to the timeslot format of TD-SCDMA, the signal vector sent to each UE by the base station in corresponding timeslot is composed of the training sequence and the spread user signal.

With regard to the UEs allocated in the same timeslot, the base station first combines the signal vectors to be transmitted to each UE into a combined signal vector, and then transmits this combined signal vector in the timeslot to each UE. Said combined signal vector is also composed of user signal and training sequence, wherein the user signal in the combined signal vector is obtained by combining the spread user signal in the signal vector to be transmitted to each UE, and the training sequence in the combined signal vector is obtained by combing the training sequence in the signal vector to be transmitted to each UE.

The training sequence allocated to each UE in a cell is obtained through performing different shift operation on the same basic training sequence, so the training sequence of the combined signal vector can be considered as the basic training sequence. Each UE has acquired the basic training sequence used by its cell during cell search procedure, so the training sequence sent by the base station in the timeslot is known beforehand to each UE.

Let's suppose that the training sequence included in the signal vector sent by the base station in a timeslot reaches a UE through at least one propagation path, the signal vector received by the UE in the timeslot is r, composed of said training sequence and noise vector n, and the known value of said training sequence is s. According to equation (1), signal vector r can be expressed as follows:
r=Hs+n (2)
wherein H is the CIR matrix constructed by the CIR of each propagation path between the UE and the base station.

According to the channel estimation method as described in “Low Cost Channel Estimation in the uplink receiver of CDMA mobile radio systems”, Frequenz, vol. 47, pp. 292-298, Nov./Dec. 1993, by B. Steiner and P. W. Baier, the maximum likelihood estimated value ŝ of the training sequence included in signal vector r can be expressed as follows:
ŝ=(H^{H}H)⁻¹H^{H}r=s+(H^{H}H)⁻¹H^{H}n=s+n′ (3)

wherein superscript ^{H} represents complex conjugate transposition.

From equation (3), according to the known value s of the training sequence contained in signal vector r, the estimated value n′ of noise vector n can be given by:
n′=ŝ−s=(H^{H}H)⁻¹H^{H}n (4)

With the covariance matrix being:

$$\begin{matrix}E \{ {n}^{′} {n}^{′ H} \} = E \{ {( {H}^{H} H )}^{- 1} {H}^{H} n \cdot {n}^{H} {H ( {H}^{H} H )}^{- 1} \} \\ = {( {H}^{H} H )}^{- 1} {H}^{H} E ( n {n}^{H} ) {H ( {H}^{H} H )}^{- 1} \} \\ = {{σ}^{2} ( {H}^{H} H )}^{- 1}\end{matrix} \qquad ( 5 )$$

wherein E{.} denotes expectation operation. By carrying out the operation of matrix trace between the two sides of above equation (5), it is easy to come down to following formulation computing the average variance σ̅_{n′}² of the estimated value n′ of the noise vector n:
σ̅_{n′}²=σ²·trace{(H^{H}H)⁻¹}/N (6)

wherein N is the chip duration of the training sequence, operator trace (·) means the computation of a matrix trace, σ² is the noise variance of the signal vector r.

If σ̅_{n′}² is computed with conventional methods, it will be very complicated. In fact, the computation of variance σ̅_{n′}² can be approximated by calculating the mean squared value of all elements about the estimated value n′ of the noise vector n located in one training sequence time duration if the channel could be regarded as constant at that time. The noise variance σ² of the signal vector r can now be deduced as:
σ²≈(n′^{H}n′)/trace {(H^{H}H)^{-1}} (7)

To further improve the estimation performance, we can sum and average the noise variance σ² calculated from equation (7) in the timeslot and the noise variance σ² calculated from equation (7) in each previous timeslot, and take the mean of different σᵢ² as the noise variance σ² of signal vector r in the timeslot.

The above section describes the principle of computing noise variance by exploiting training sequence in the present invention.

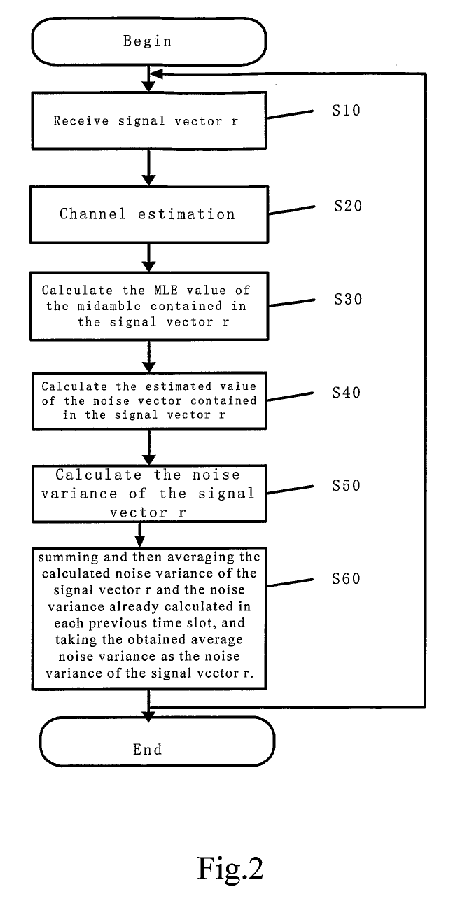

The following section will describe the proposed noise variance estimation method in detail, in conjunction with FIG. 2.

First, the UE receives a signal vector containing training sequence and noise vector in a timeslot transferred through at least one propagation path from the base station (step S10).

Secondly, the UE estimates the CIR of each propagation path according to the received signal vector, and constructs a CIR matrix H by using the estimated CIR of each propagation path (step S20).

Thirdly, the UE estimates the maximum likelihood estimated value ŝ of the training sequence included in said signal vector using equation (3), according to said signal vector and said CIR matrix (step S30).

Fourthly, the UE computes the estimated value n′ of the noise vector contained in said signal vector by using equation (4), according to the MLE (maximum likelihood estimate) value ŝ of the training sequence included in said signal vector and the known value of the training sequence (step S40). Wherein, the known value of the training sequence contained in said signal vector is acquired by the UE in cell search procedure.

Fifthly, the UE computes the noise variance σ² of said signal vector by using equation (7), according to the estimated value n′ of the noise vector contained in said signal vector and said CIR matrix H (step S50). Wherein first the power pₙ² of n′ can be computed according to equation pₙ²=(n′)^{H}(n′); then the trace cf of matrix ((H^{H}H) can be computed, that is cf=trace((H^{H}H)⁻¹); lastly, the noise variance σ² can be computed according to equation σ²=pₙ²/cf, that is equation (7).

Lastly, the UE sums and averages the noise variance σ² calculated from equation (7) in the timeslot and the noise variance σ² calculated from equation (7) in each previous timeslot, and takes the mean of different σᵢ², as the noise variance σ² of signal vector r in the timeslot (step S60).

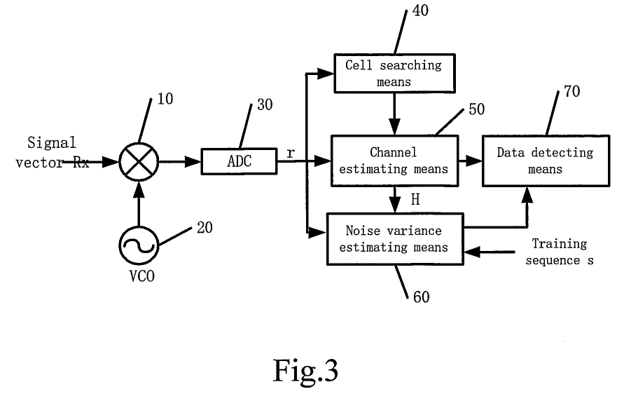

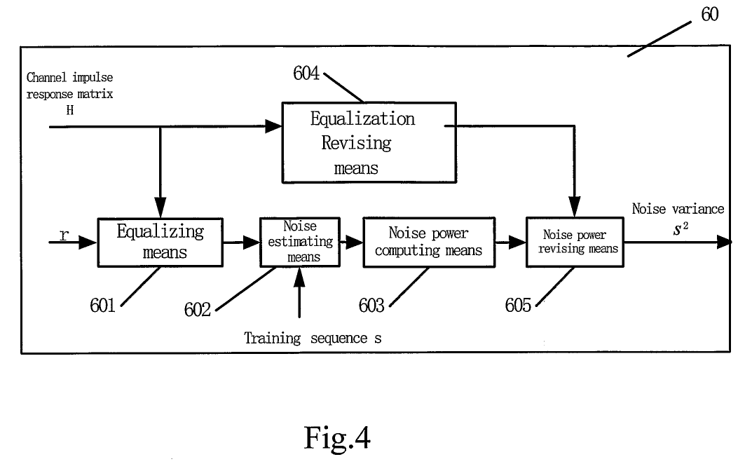

A detailed description will be given below to the proposed noise variance estimation apparatus, in conjunction with FIG. 3 and FIG. 4.

FIG. 3 is a block diagram illustrating the UE equipped with the proposed noise variance estimation apparatus. As FIG. 3 shows, in cell search procedure before the UE communicates with the base station, cell searching means 40 acquires the basic training sequence s used by the cell where the UE is camping. When the UE communicates with the base station, the antenna of the UE first sends the sign al vector Rx received in a timeslot to multiplier 10, and multiplier 10 multiplies the received signal vector Rx by the RF carrier generated by VCO 20, to convert signal vector Rx into baseband signal vector. Then, ADC 30 converts the baseband signal vector outputted from multiplier 10 into digital baseband signal vector r. Afterwards, cell searching means 40 synchronizes the digital baseband signal vector r outputted from ADC 30, and channel estimating means 50 computes the CIR of each propagation channel for the synchronized digital baseband signal vector r by using conventional channel estimation methods, and constructs CIR matrix with the computed CIR of each propagation path. Next, noise variance estimating means 60 computes the noise variance of the digital baseband signal vector r according to the CIR matrix computed by channel estimating means 50, the digital baseband signal vector r outputted by ADC 30 and the basic training sequence s acquired by cell searching means 40. Finally, data detecting means 70 acquires the desired user signal from the digital baseband signal vector r according to the noise variance computed by noise variance estimating means 60, by using conventional data detection methods, such as multiuser detection method, turbo-code decoding and etc.

FIG. 4 is a block diagram illustrating noise variance estimating means 60. Referring to FIG. 4, noise variance estimating means 60 comprises:

equalizing means 601, for estimating the MLE value ŝ of the training sequence contained in said digital baseband signal vector r according to the CIR matrix H computed by channel estimating means 50 and the digital baseband signal vector r outputted by ADC 30, by using equation (3);

noise estimating means 602, for calculating the estimated value n′of the noise vector contained in said digital baseband signal vector r according to the MLE value ŝ of the training sequence contained in said digital baseband signal vector r computed by equalizing means 601, and the basic training sequence s (or namely the known value of the training sequence contained in said digital baseband signal vector r), by using equation (4);

noise power calculating means 603, for calculating the power pₙ² of the estimated value n′ of said noise vector according to the estimated value n′ of the noise vector contained in said digital baseband signal vector r computed by noise estimating means 602, by using equation pₙ²=(n′)^{H}(n′);

equalization revising means 604, for computing the trace cf of matrix ((H^{H}H)⁻¹), that is cf=trace((H^{H}H)⁻¹);

noise power revising means 605, for calculating the noise variance σ² according to the power pₙ² of the estimated value n′ of said noise vector calculated by noise power computing means 603 and the trace cf computed by equalization revising means 604, by using equation σ²=pₙ²/cf.

### BENEFICIAL RESULTS OF THE INVENTION

As described above, in the proposed noise variance estimation method and apparatus for use in wireless communication systems, training sequence is used to compute the noise variance, so the computed noise variance can meet the requirement for higher accuracy.

It is to be understood by those skilled in the art that the method and apparatus of noise variance estimation for use in wireless communication systems as disclosed in this invention can be modified considerably without departing from the spirit and scope of the invention as defined by the appended claims.

1. A method of noise variance estimation to be performed by a user equipment, comprising steps of:
(a) receiving a signal vector containing training sequence and noise vector transmitted via at least one propagation path from the base station;
(b) estimating the channel impulse response of each propagation path to construct a channel impulse response matrix, according to the signal vector;
(c) calculating the noise variance of the signal vector according to the channel impulse response matrix and the signal vector if the channel impulse response remains primarily unchanged during the special time duration of the training sequence.

2. The method according to claim 1, wherein said special time duration is the time duration of said training sequence.

3. The method according to claim 2, wherein step (c) includes:
(c1) estimating the MLE (maximum likelihood estimation) value of the training sequence contained in said signal vector according to said channel impulse response matrix and said signal vector;
(c2) calculating the estimated value of the noise vector contained in said signal vector according to the MLE value of the training sequence and the known value of said training sequence;
(c3) calculating the noise variance of said signal vector according to the estimated value of the noise vector and said channel impulse response matrix.

4. The method according to claim 3, wherein step (c3) calculates the noise variance of said signal vector with the following formula:
σ²≈(n′^{H}n′)/trace{(H^{H}H)⁻¹}
wherein:
σ² is the noise variance of said signal vector;
n′is the estimated value of the noise vector contained in said signal vector;
H is said channel impulse response matrix, and superscript ^{H} represents complex conjugate transposition;
trace{·} denotes computation of a matrix trace.

5. The method according claim 3, wherein further comprising:
summing and then averaging the noise variance of said signal vector and the noise variance computed in previous time slot, and taking the average noise variance as the noise variance of said signal vector.

6. An apparatus for noise variance estimation, comprising:
receiving means for receiving a signal vector containing training sequence and noise vector transmitted via at least one propagation path from the base station;
channel estimating means for estimating the channel impulse response of each propagation path to construct a channel impulse response matrix, according to the signal vector;
calculating means for calculating the noise variance of the signal vector according to the channel impulse response matrix and the signal vector if the channel impulse response remains primarily unchanged during special time duration of the training sequence.

7. The apparatus according to claim 6, wherein said special time duration is the time duration of said training sequence.

8. The apparatus according to claim 7, wherein said calculating means includes:
equalizing means for estimating the MLE value of the training sequence contained in said signal vector according to said channel impulse response matrix and said signal vector;
noise estimating means for calculating the estimated value of the noise vector contained in said signal vector according to the MLE value of the training sequence and the known value of said training sequence;
noise power calculating means for calculating the power of the estimated value of said noise vector according to the estimated value of said signal vector;
noise power revising means for calculating the noise variance of said signal vector according to the power of the estimated value of the noise vector and said channel impulse response matrix.

9. The apparatus according to claim 8, wherein said noise power revising means calculates the noise variance of said signal vector with the following formula:
σ²≈(n′^{H}n′)/trace{(H^{H}H)⁻¹}
wherein:
σ² is the noise variance of said signal vector;
n′is the estimated value of the noise vector contained in said signal vector and n′^{H}n′ is the power of the estimated value of said noise vector;
H is said channel impulse response matrix, and superscript ^{H} represents complex conjugate transposition;
trace{·} denotes computation of a matrix trace.

10. A user equipment, comprising:
receiving means for receiving a signal vector containing training sequence and noise vector transmitted via at least one propagation path from the base station;
channel estimating means for estimating the channel impulse response of each propagation path to construct a channel impulse response matrix, according to the signal vector;
noise variance estimating means for calculating the noise variance of the signal vector according to the channel impulse response matrix and the signal vector if the channel impulse response remains primarily unchanged-during special time duration of the training sequence;
data detecting means for detecting the received signal vector to obtain the desired signal according to the computed noise variance of the signal vector.

11. The user equipment according to claim 10, wherein said special time duration is the time duration of said training sequence.

12. The user equipment according to claim 11, wherein said noise variance estimating means includes:
equalizing means, for estimating the MLE value of the training sequence contained in said signal vector according to said channel impulse response matrix and said signal vector;
noise estimating means for calculating the estimated value of the noise vector contained in said signal vector according to the MLE value of the training sequence and the known value of said training sequence;
noise power calculating means for calculating the power of the estimated value of said noise vector according to the estimated value of said signal vector;
noise power revising means for calculating the noise variance of said signal vector according to the estimated value of the noise vector and said channel impulse response matrix.

13. The user equipment according to claim 12, wherein said noise power revising means calculates the noise variance of said signal vector with the following formula:
σ²≈(n′^{H}n′)/trace{(H^{H}H)⁻¹}
wherein:
σ² is the noise variance of said signal vector;
n′ is the estimated value of the noise vector contained in said signal vector and n′^{H}n′ is the power of the estimated value of said noise vector;
H is said channel impulse response matrix, and superscript ^{H} represents complex conjugate transposition;
trace{·} denotes computation of a matrix trace.
